(19) United States
(12) Patent Application Publication
(10) Pub. No.: US 2026/0371228 A1
(43) Pub. Date: Nov. 19, 2026

(54) OPTIMIZING CELLULAR WIRELESS NETWORK SEARCHING BY A MULTIPLE SIM/ESIM WIRELESS DEVICE

(71) Applicant: Apple Inc., Cupertino, CA (US)

(72) Inventors: Nirlesh KOSHTA, Bangalore (IN); Pradeep PANGI, Bengaluru (IN); Karthik RAMAMURTHY, Bangalore (IN); Shrinidhi RAMACHANDRA, Bangalore (IN); Madhusudhan CHERIPALLY, Bengaluru (IN)

(21) Appl. No.: 19/145,286

(22) PCT Filed: Dec. 26, 2023
(86) PCT No.: PCT/US2023/085892

§ 371 Date: Jul. 2, 2025

(30) Foreign Application Priority Data
Jan. 4, 2023 (IN) 202311000582

(51) Int. Cl. H04W 48/16; H04W 76/27

(52) U.S. Cl. CPC H04W 48/16; H04W 76/27

(57) ABSTRACT

This application regards optimizing cellular wireless network searches by a wireless device that supports multiple subscriber identity modules (SIMs) and/or electronic SIMs (eSIMs). The wireless device includes at least two active SIM/eSIMs, each SIM/eSIM associated with a distinct modem. A first modem performs PLMN searches and provides search results to a second modem, which forgoes or delays its own PLMN searches. PLMN search results are provided as soon as a PLMN is detected by the first modem, and the second modem can camp on (or reselect to) a higher/highest priority PLMN detected and reported by the first modem without waiting for additional PLMN search results. When a first modem of the wireless device is in a limited or normal service mode, the second modem ignores system information block (SIB) messages for emergency alerts and relies on the first modem for monitoring SIB messages and providing access to emergency services.

### FIELD

The described embodiments relate to wireless communications, including methods and apparatus to optimize cellular wireless network searching on a wireless device that supports multiple subscriber identity modules (SIMs) and/or electronic SIMs (eSIMs).

### BACKGROUND

Many wireless devices are configured to use removable Universal Integrated Circuit Cards (UICCs) that enable the wireless devices to access services provided by Mobile Network Operators (MNOs), which may also be referred to as carriers. Each UICC includes a microprocessor and a read-only memory (ROM), where the ROM is configured to store a subscriber identity module (SIM) profile that the wireless device can use to register and interact with an MNO to obtain wireless services via a cellular wireless network. Typically, a UICC takes the form of a small removable card, commonly referred to as a SIM card, which is inserted into a UICC-receiving bay of a wireless device. In more recent implementations, UICCs are being embedded directly into system boards of wireless devices as embedded UICCs (eUICCs), which can provide advantages over traditional, removable UICCs. The eUICCs can include a rewritable memory that can facilitate installation, modification, and/or deletion of one or more electronic SIMs (eSIMs) on the eUICC, where the eSIMs can provide for new and/or different services and/or updates for accessing extended features provided by MNOs. An eUICC can store a number of MNO profiles—also referred to herein as eSIMs—and can eliminate the need to include UICC-receiving bays in wireless devices. A wireless device can include multiple SIMs and/or eSIMs to provide access to different cellular wireless service subscriptions. The wireless device can maintain distinct modem software stacks to support communication via each of the SIMs and/or eSIMs. Performing public land mobile network (PLMN) searches, such as when roaming, when searching for a higher priority PLMN, during an out-of-service (OOS) recovery procedure, or while in a limited service mode, can waste computing resources for and limited battery power in a mobile wireless device for duplication of PLMN searches by multiple SIMs/eSIMs. Similarly, monitoring system information (SI) for each SIM and/or eSIM from the same cell independently by each software stack can be less efficient. There exists a need for optimizing wireless network searches and monitoring of SI and sharing search results among multiple software stacks associated with different SIMs and/or eSIMs of a wireless device that supports multiple SIMs and/or eSIMs.

### SUMMARY

This application relates to wireless communications, including methods and apparatus for optimizing cellular wireless network searching on a wireless device that supports multiple subscriber identity modules (SIMs) and/or electronic SIMs (eSIMs), which can be referred to as a multi-SIM/eSIM wireless device. A multi-SIM/eSIM wireless device can include multiple distinct SIMs and/or eSIMs, each associated with different subscriptions for access to cellular wireless services of various MNOs. In some cases, the multi-SIM/eSIM wireless device can include common cellular wireless circuitry that allows for communicating with only one cellular wireless network at a time. The multi-SIM/eSIM wireless device can efficiently perform public land mobile network (PLMN) searches, e.g., to find a suitable service for the multi-SIM/eSIM wireless device, to switch to a higher priority PLMN, or to perform an out-of-service (OOS) recovery procedure. The multi-SIM/eSIM wireless device can share information regarding PLMNs by a first modem, e.g., a first software stack associated with a first SIM/eSIM and configured to communicate via wireless circuitry of the multi-SIM/eSIM wireless device, with a second modem, e.g., a second software stack associated with a second SIM/eSIM and configured to communicate via the same wireless circuitry. Sharing detected PLMN information across multiple searched radio access technologies (RATs) and associated radio frequency (RF) bands can reduce power consumption for duplicate searches and focus searching by the second modem to speed PLMN detection. In some embodiments, the first modem of the multi-SIM/eSIM wireless device performs a high priority (HP) PLMN (HPPLMN) search and indicates the HPPLMN search results to the second modem of the multi-SIM/eSIM wireless device, which can stop and subsequently restart an HPPLMN timer to avoid performing a separate HPPLMN search when no HPPLMN for the second modem is detected by the first modem and all configured RATs and RF bands for the second modem were searched by the first modem. In some embodiments, the first modem reports detected PLMNs during the PLMN search, e.g., when each PLMN detected or when a searched RAT and/or RF band completes, and the second modem can receive and act on the reported PLMNs. In some embodiments, the second modem initiates an immediate search for a highest priority PLMN reported by the first modem without waiting for the PLMN search by the first modem to complete. In some embodiments, the second modem waits for further PLMN search results when receiving an indication that the first modem detected a higher priority PLMN that is not the highest priority PLMN for the second modem. In some embodiments, when a wireless network search by a first modem, e.g., a PLMN search, an HPPLMN search, or a limited service camping search, terminates before completion of the wireless network search, the first modem provides an indication of the wireless network search termination, and the second modem determines whether to initiate a separate wireless network search.

In some embodiments, when a first modem of the multi-SIM/eSIM wireless device camps on a cellular wireless network in a limited service mode, e.g., to provide access to emergency service information, or in a normal service mode, a second modem of the multi-SIM/eSIM wireless device refrains from camping in the limited service mode (when unable to camp in a normal service mode) and performs periodic cellular wireless network searches for normal service on any available PLMN based on wireless network search information provided by the first modem. In some embodiments, the second modem does not monitor select broadcast system information block (SIB) messages, such as SIB type one (SIB-1) and SIB type two (SIB-2) messages, and relies on the first modem to receive the same SIB messages and monitor for emergency alerts accordingly. Should the first modem enter an OOS state, the second modem can resume PLMN searching and camp on a wireless network in a limited service mode if normal service is unavailable.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement cellular service provisioning to a wireless device, according to some embodiments.

FIG. 2 illustrates a block diagram of a more detailed view of exemplary components of the system of FIG. 1, according to some embodiments.

FIG. 3A illustrates an example of a multiple subscriber identity module (SIM)/electronic SIM (eSIM) wireless device communicating with two wireless networks, according to some embodiments.

FIG. 3B illustrates examples of wireless devices that support multiple subscriber identities, according to some embodiments.

FIG. 4 illustrates diagrams of an exemplary optimization of high priority public land mobile network (HPPLMN) searching by a multi-SIM/eSIM wireless device, according to some embodiments.

FIG. 5 illustrates diagrams of an exemplary optimization of PLMN searching by a multi-SIM/eSIM wireless device in a limited service mode, according to some embodiments.

FIG. 6 illustrates a flow diagram of an exemplary optimization of PLMN searching with early PLMN search results reporting by a multi-SIM/eSIM wireless device, according to some embodiments.

FIG. 7 illustrates a flow diagram of an exemplary optimization of HPPLMN searching with one or both modems of a multi-SIM/eSIM wireless device in a radio resource control (RRC) connected mode while roaming, according to some embodiments.

FIG. 8 illustrates a flow diagram of an exemplary optimization of HPPLMN searching with multiple modems of a multi-SIM/eSIM wireless device in a radio resource control (RRC) idle mode, according to some embodiments.

FIG. 9 illustrates a flow diagram of another exemplary optimization of HPPLMN searching with multiple modems of a multi-SIM/eSIM wireless device in an RRC idle mode, according to some embodiments.

FIG. 10 illustrates a flow diagram of an exemplary optimization of PLMN searching with an interruption of the PLMN searching by a multi-SIM/eSIM wireless device, according to some embodiments.

FIG. 11 illustrates a flowchart of an exemplary method for optimization of PLMN searching by a multi-SIM/eSIM wireless device, according to some embodiments.

FIG. 12A illustrates a flowchart of an exemplary method for optimization of PLMN searching by a multi-SIM/eSIM wireless device while in a limited service mode, according to some embodiments.

FIG. 12B illustrates a flowchart of an exemplary method for optimization of PLMN searching by a multi-SIM/eSIM wireless device while in a normal service mode, according to some embodiments.

FIG. 13 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

This application relates to wireless communications, including methods and apparatus for optimizing cellular wireless network searching on a wireless device that supports multiple subscriber identity modules (SIMs) and/or electronic SIMs (eSIMs), which can be referred to as a multi-SIM/eSIM wireless device. A multi-SIM/eSIM wireless device can include multiple distinct SIMs and/or eSIMs, each associated with different subscriptions for access to cellular wireless services of various MNOs. In some cases, the multi-SIM/eSIM wireless device can include common cellular wireless circuitry that allows for communicating with only one cellular wireless network at a time. The multi-SIM/eSIM wireless device can efficiently perform public land mobile network (PLMN) searches such as to find a suitable service for the multi-SIM/eSIM wireless device, e.g., a voice service or a data service, or to switch to a higher priority PLMN, which can reduce roaming costs for a user of the multi-SIM/eSIM wireless device (and in some cases for the home PLMN). For example, the multi-SIM/eSIM wireless device can select an initial PLMN while roaming and later change the PLMN based on a high priority PLMN search. The multi-SIM/eSIM wireless device can also perform an out-of-service (OOS) recovery procedure to locate a PLMN on which to camp for normal service or in some cases to camp on in a limited service mode when normal service is otherwise unavailable. Mechanisms to perform PLMN searches are not standardized by cellular wireless standards organizations, such as 3GPP, and implementations can vary for different wireless devices. Optimizing PLMN searching for a multi-SIM/eSIM wireless device can reduce duplication of PLMN search efforts by different modems associated with different SIMs/eSIMs and thereby reduce battery power consumption for PLMN searching. Battery performance is a performance metric important to users of multi-SIM/eSIM wireless devices.

The multi-SIM/eSIM wireless device can share information regarding PLMNs by a first modem, e.g., a first software stack associated with a first SIM/eSIM and configured to communicate via wireless circuitry of the multi-SIM/eSIM wireless device, with a second modem, e.g., a second software stack associated with a second SIM/eSIM and configured to communicate via the same (or separate) wireless circuitry. Sharing detected PLMN information across multiple searched radio access technologies (RATs) and associated radio frequency (RF) bands can reduce power consumption for duplicate searches and focus searching by the second modem to speed PLMN detection. Recovery of service for multiple active SIMs/eSIMs of a multi-SIM/eSIM wireless device is improved when PLMN search results are shared between SIMs/eSIMs to allow for quicker recovery and avoid searching for PLMNs already located or already determined to be unavailable. In addition, when a multi-SIM/eSIM wireless device is unable to establish normal service for any active SIM/eSIM, only one active SIM/eSIM needs to camp on a cellular wireless network in a limited service mode to allow for listening to broadcast system information (SI) messages, e.g., SI block type 1 (SIB-1) and SI block type 2 (SIB-2) messages that can provide information whether there are additional broadcast emergency alert messages, e.g., Earthquake and Tsunami Warning System (ETWS) and Commercial Mobile Alert System (CMAS) messages. The SIM/eSIM camped on the cellular wireless network in the limited service mode can be relied on for receiving the ETWS/CMAS alert messages, and therefore other active SIMs/eSIMs need not camp on a cellular wireless network in a limited service mode and wake from reduced power states to listen for SIB and alert messages in parallel with the other SIM/eSIM already camped in the limited service mode.

In some embodiments, the first modem of the multi-SIM/eSIM wireless device performs a high priority (HP) PLMN (HPPLMN) search and indicates the HPPLMN search results to the second modem of the multi-SIM/eSIM wireless device, which can stop and subsequently restart an HPPLMN timer to avoid performing a separate HPPLMN search when no HPPLMN for the second modem is detected by the first modem and all configured RATs and RF bands for the second modem were searched by the first modem. In some embodiments, the first modem reports detected PLMNs during the PLMN search, e.g., when each PLMN detected or when a searched RAT and/or RF band completes, and the second modem can receive and act on the reported PLMNs as soon as reported. In some embodiments, the second modem initiates an immediate search for a highest priority PLMN reported by the first modem without waiting for the PLMN search by the first modem to complete. In some embodiments, the second modem waits for further PLMN search results when receiving an indication that the first modem detected a higher priority PLMN that is not the highest priority PLMN for the second modem. In some embodiments, when a wireless network search by a first modem, e.g., a PLMN search, an HPPLMN search, or a limited service camping search, terminates before the first modem completes the wireless network search, the first modem provides an indication of the premature wireless network search termination, and the second modem determines whether to initiate a separate wireless network search. In some embodiments, the first modem indicates which radio access technologies (RATs) were searched, which radio frequency (RF) bands were searched, whether a search is complete or incomplete (e.g., ongoing or prematurely terminated) when providing PLMN search results to a second modem of the multi-SIM/eSIM wireless device.

In some embodiments, when a first modem of the multi-SIM/eSIM wireless device camps on a cellular wireless network in a limited service mode, e.g., to provide access to emergency service information, or in a normal service mode, a second modem of the multi-SIM/eSIM wireless device refrains from camping in the limited service mode (when unable to camp in a normal service mode) and performs periodic cellular wireless network searches for normal service on any available PLMN based on wireless network search information provided by the first modem. In some embodiments, the second modem does not monitor select broadcast system information block (SIB) messages, such as SIB type one (SIB-1) and SIB type two (SIB-2) messages, and relies on the first modem to receive the same SIB messages and monitor for emergency alerts accordingly. Should the first modem enter an OOS state, the second modem can resume PLMN searching and camp on a wireless network in a limited service mode if normal service is unavailable.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

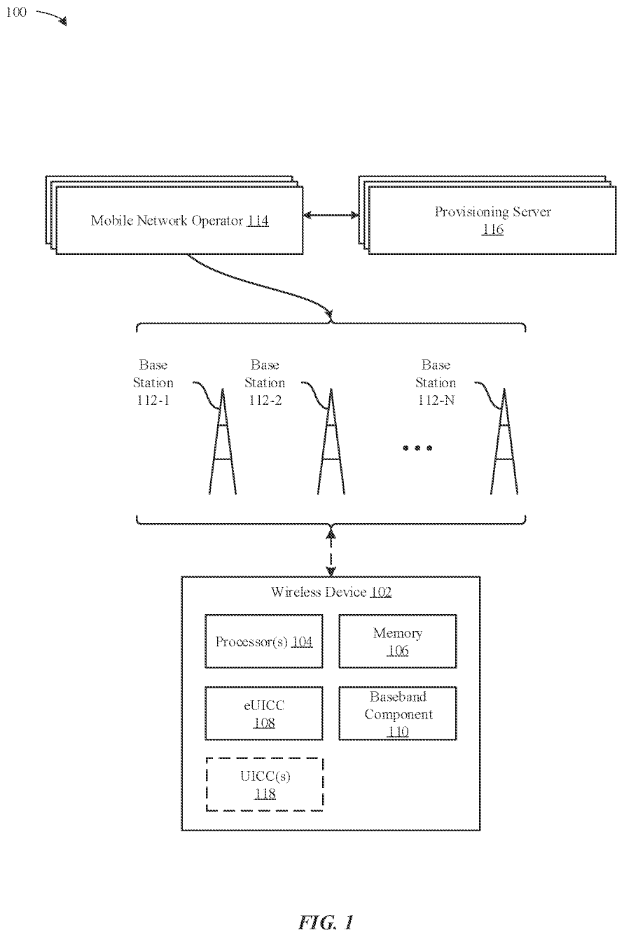

These and other embodiments are discussed below with reference to FIGS. 1 through 13; however, those skilled in the art will readily appreciate that the detailed description given herein with respect to these figures is for explanatory purposes only and should not be construed as limiting.

FIG. 1 illustrates a block diagram of different components of a system 100 that includes i) a wireless device 102, which can also be referred to as a mobile wireless device, a wireless communication device, a mobile device, a user equipment (UE), a device, and the like, ii) a group of base stations 112-1 to 112-N, which are managed by different Mobile Network Operators (MNOs) 114, and iii) a set of provisioning servers 116 that are in communication with the MNOs 114. The wireless device 102 can represent a mobile computing device (e.g., an iPhone® or an iPad® by Apple®) or a wearable cellular-capable device (e.g., an Apple Watch®). The base stations 112-1 to 112-N can represent cellular wireless network entities including fourth generation (4G) Long Term Evolution (LTE) evolved NodeBs (eNodeBs or eNBs) and/or fifth generation (5G) NodeBs (gNodeBs or gNBs) that are configured to communicate with the wireless device 102. The MNOs 114 can represent different wireless service providers that provide specific services (e.g., voice and data) to which a user of the wireless device 102 can subscribe to access the services via the wireless device 102. Applications resident on the wireless device 102 can advantageously access services using 4G LTE connections and/or 5G connections via the base stations 112. The wireless device 102 can include processing circuitry, which can include one or more processors 104 and a memory 106, an embedded Universal Integrated Circuit Card (eUICC) 108, and a baseband component 110. In some embodiments, the wireless device 102 includes one or more physical UICCs 118, also referred to as Subscriber Identity Module (SIM) cards, in addition to the eUICC 108. The components of the wireless device 102 work together to enable the wireless device 102 to provide useful features to a user of the wireless device 102, such as cellular wireless network access, non-cellular wireless network access, localized computing, location-based services, and Internet connectivity. The eUICC 108 can be configured to store multiple electronic SIMs (eSIMs) for accessing services offered by one or more different MNOs 114 via communication through base stations 112-1 to 112-N. Similarly, one or more UICCs 118 can include universal SIMs (USIMs) for access to associated MNO 114 services. To be able to access services provided by the MNOs, one or more eSIMs can be provisioned to the eUICC 108 of the wireless device 102 (or one or more UICCs 118 installed in the wireless device 102).

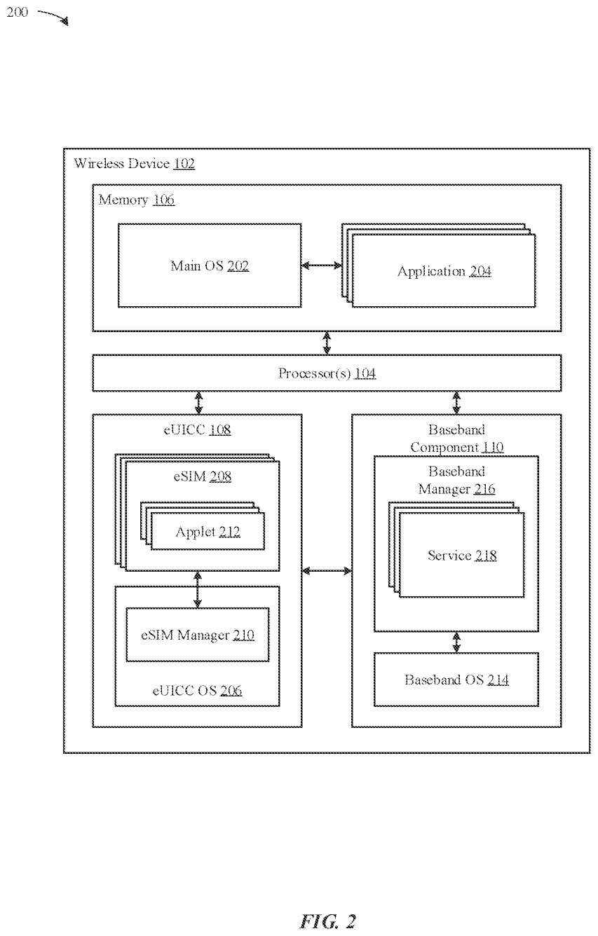

FIG. 2 illustrates a block diagram 200 of a more detailed view of the wireless device 102 of FIG. 1. The one or more processors 104, in conjunction with the memory 106, can implement a main operating system (OS) 202 that is configured to execute applications 204 (e.g., native OS applications and user applications). The one or more processors 104 can include applications processing circuitry and, in some embodiments, wireless communications control circuitry. The applications processing circuitry can monitor application requirements and usage to determine recommendations about communication connection properties, such as bandwidth and/or latency, and provide information to the communications control circuitry to determine suitable wireless connections for use by particular applications. The communications control circuitry can process information from the applications processing circuitry as well as from additional circuitry, such as the baseband component 110, and other sensors (not shown) to determine states of components of the wireless device 102, e.g., reduced power modes, as well as of the wireless device 102 as a whole, e.g., mobility states. The wireless device 102 includes an eUICC 108 that can be configured to implement an eUICC OS 206 to manage the hardware resources of the eUICC 108 (e.g., a processor and a memory embedded in the eUICC 108). The eUICC OS 206 can also be configured to manage eSIMs 208 that are stored by the eUICC 108, e.g., by enabling, disabling, modifying, updating, or otherwise performing management of the eSIMs 208 within the eUICC 108 and providing the baseband component 110 with access to the eSIMs 208 to provide access to wireless services for the wireless device 102. The eUICC OS 206 can include an eSIM manager 210, which can perform management functions for various eSIMs 208. Each eSIM 208 can include a number of applets 212 that define the manner in which the eSIM 208 operates. For example, one or more of the applets 212, when implemented by the baseband component 110 and the eUICC 108, can be configured to enable the wireless device 102 to communicate with an MNO 114 and provide useful features (e.g., phone calls and internet) to a user of the wireless device 102.

A baseband component 110 of the wireless device 102 can include a baseband OS 214 that is configured to manage hardware resources of the baseband component 110 (e.g., a processor, a memory, different radio components, etc.). According to some embodiments, the baseband component 110 can implement a baseband manager 216 that is configured to interface with the eUICC 108 to establish a secure channel with a provisioning server 116 and obtaining information (such as eSIM data) from the provisioning server 116 for purposes of managing eSIMs 208. The baseband manager 216 can be configured to implement services 218, which represents a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108.

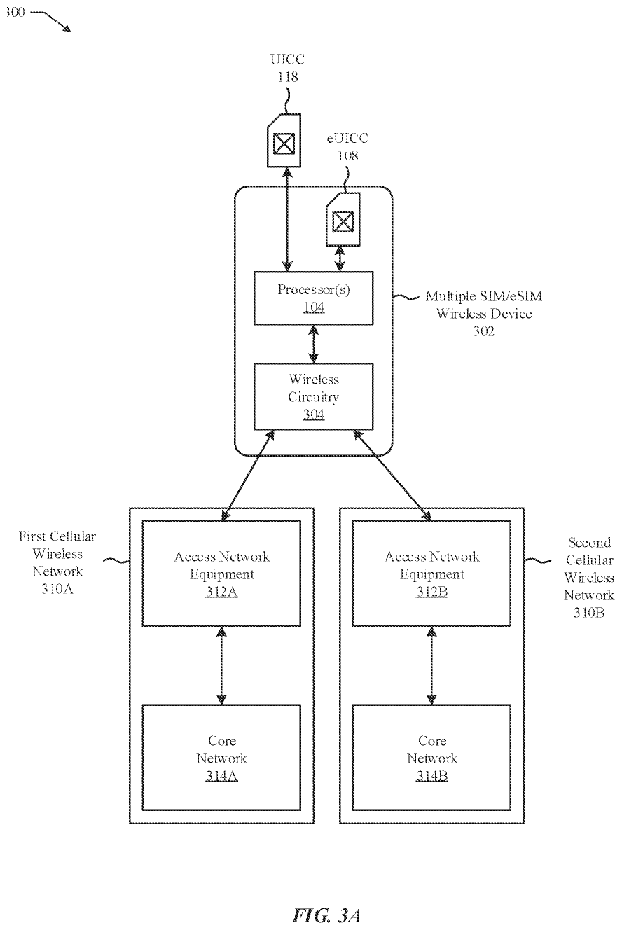

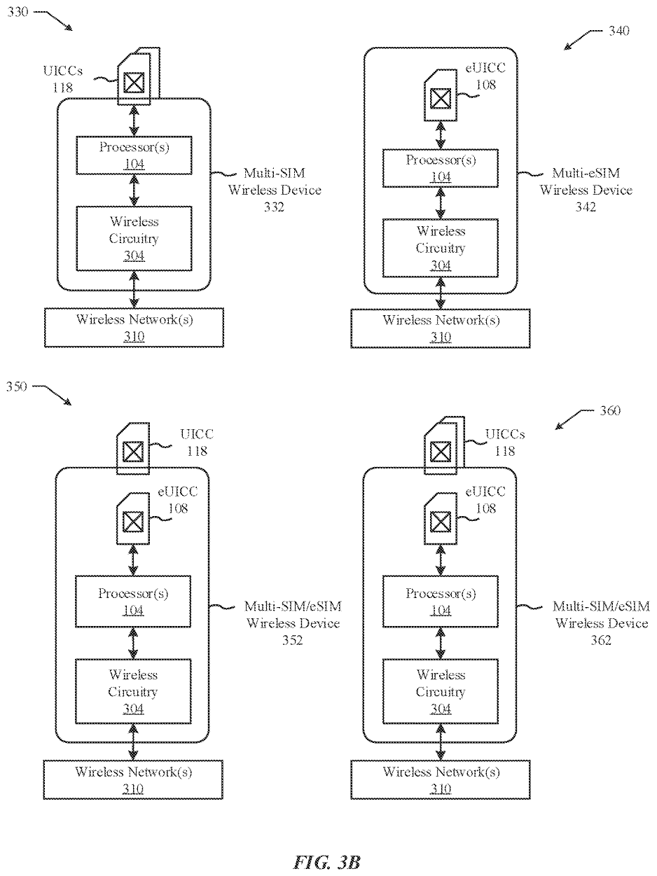

FIG. 3A illustrates a diagram 300 of a multi-SIM/eSIM wireless device 302, which can be a form of wireless device 102, including one or more processor(s) 104 and wireless circuitry 304 that provides for wireless radio frequency (RF) connections between the multi-SIM/eSIM wireless device 302 and a first cellular wireless network 310A and a second cellular wireless network 310B. In some embodiments, the wireless circuitry 304 includes one or more baseband processor(s), and a set of RF analog front-end circuitry. In some embodiments, the wireless circuitry 304 and/or a portion thereof can include or be referred to as a wireless transmitter/receiver or a transceiver or a radio. The terms circuit, circuitry, component, and component block may be used interchangeably herein, in some embodiments, to refer to one or more operational units of a wireless device that process and/or operate on digital signals, analog signals, or digital data units used for wireless communication. For example, representative circuits can perform various functions that convert digital data units to transmitted radio frequency analog waveforms and/or convert received analog waveforms into digital data units including intermediate analog forms and intermediate digital forms. The wireless circuitry 304 can include components of RF analog front-end circuitry, e.g. a set of one or more antennas, which can be interconnected with additional supporting RF circuitry that can include filters and other analog components that can be “configured” for transmission and/or reception of analog signals via one or more corresponding antennas to one of the first and second cellular wireless networks 310A/B.

In some embodiments, the multi-SIM/eSIM wireless device 302 can include hardware restrictions that limit the multi-SIM/eSIM wireless device 302 to connect to only one of the first and second cellular wireless networks 310A/310B via their respective access network equipment 312A/312B at a time. For example, the wireless circuitry 304 can include a single transmitter and one or more receivers used for cellular wireless communication, so that only one active bi-directional cellular radio frequency connection to a cellular access network can be used at a time. When the multi-SIM/eSIM wireless device 302 has an active connection via the access network equipment 312A of the first cellular wireless network 310A, the multi-SIM/eSIM wireless device 302 can be precluded from establishing another active connection via the access network equipment 312B of the second cellular wireless network 310B (or from establishing a second active connection to the first cellular wireless network 310A). In some embodiments, the multi-SIM/eSIM wireless device 302 can be registered with multiple subscriptions that correspond to different SIMs/eSIMs at the same time.

The multi-SIM/eSIM wireless device 302 can register with multiple wireless networks, e.g., the first and second cellular wireless networks 310A/B, simultaneously. The wireless circuitry 304 of the multi-SIM/eSIM wireless device 302 can be configured to register with and/or establish a connection with the first cellular wireless network 310A via access network equipment 312A, which interfaces with a core network 314A. The wireless circuitry 304 of the multi-SIM/eSIM wireless device 302 can also be configured to register with and/or establish a connection with the second cellular wireless network 310B via access network equipment 312B, which interfaces with a core network 314B. The wireless circuitry 304 of the multi-SIM/eSIM wireless device 302 can support transmission and reception to only one of the first and second wireless networks 310A/B, via their respective access networks 312A/B at a time. As the multi-SIM/eSIM wireless device 302 can register with two different wireless networks simultaneously via two different subscriptions, the multi-SIM/eSIM wireless device 302 can appear as two distinct devices (each associated with a different number, user, and/or subscription). A multi-SIM/eSIM wireless device 302 that can connect to only one wireless network at a time but can monitor and/or receive communication from multiple wireless networks with which it is registered can be referred to as a Multiple SIM, Multiple Standby (MSMS) wireless device (or in the case of wireless device with two SIMs/eSIMs as a dual-SIM, dual-Standby (DSDS) wireless device). In a 5G NR cellular wireless network that includes shared access network equipment with separate core networks, the multi-SIM/eSIM wireless device 302 can be connected to the same access network equipment for access to services of two different cellular wireless networks. While the multi-SIM/eSIM wireless device 302 of FIG. 3A includes a UICC 118 and an eUICC 108, other configurations for multi-SIM/eSIM wireless devices 302 are possible.

FIG. 3B illustrates diagrams of exemplary multi-SIM/eSIM wireless devices that support multiple subscriber identities using removable UICCs 118 with SIMs and/or eUICCs 108 with eSIMs 208 implemented thereon. As illustrated in diagram 330, a multi-SIM wireless device 332 includes multiple UICCs 118, which can be inserted and removed individually or together, and communicate with one or more processors 104 that connect to wireless circuitry 304 that provides for wireless communication with one or more wireless networks 310. As the physical size and design of the multi-SIM wireless device 332 can limit the number of UICCs 118 that can be supported, alternatively, as illustrated in diagram 340, a multi-eSIM wireless device 342 can include an eUICC 108 connected with the processor(s) 104 and to the wireless network(s) 310 via the wireless circuitry 304. The eUICC 108 can store multiple eSIMs 208, each eSIM 208 can be associated with a distinct subscriber identity and/or provide distinct services or subscriptions for a user of the multi-eSIM wireless device 342. Diagram 350 illustrates an exemplary multi-SIM/eSIM wireless device 352 that includes a removable UICC 118, on which can be installed one or more SIMs, and an eUICC 108 on which one or more eSIMs 208 can be installed. The multi-SIM/eSIM wireless device 352 can represent another form of the wireless device 102 of FIG. 1. Diagram 360 illustrates another multi-SIM/eSIM wireless device 362 that includes multiple UICCs 118, on which one or more SIMs can be installed, and an eUICC 108, on which one or more eSIMs 208 can be installed. The combination of SIMs on the UICCs 118 and/or eSIMs 208 on the eUICC 108 can provide for connections to one or more wireless networks 310 using the wireless circuitry 304 under the control of the processor(s) 104 of the multi-SIM/eSIM wireless device 362.

In general, a multi-SIM/eSIM wireless device that supports multiple subscriber identities can include (i) at least one UICC 118 that supports multiple SIMs, (ii) an eUICC 108 that supports multiple eSIMs 208, or (iii) a combination of a UICC 118 and an eUICC 108. Each UICC 118 can support one or more SIMs, and each eUICC 108 can support one or more eSIMs 208. A multi-SIM/eSIM wireless device that supports multiple subscriber identities, e.g., 102, 332, 342, 352, 362, can include a combination of SIMs and/or eSIMs 208 to support communication with one or more wireless networks 310.

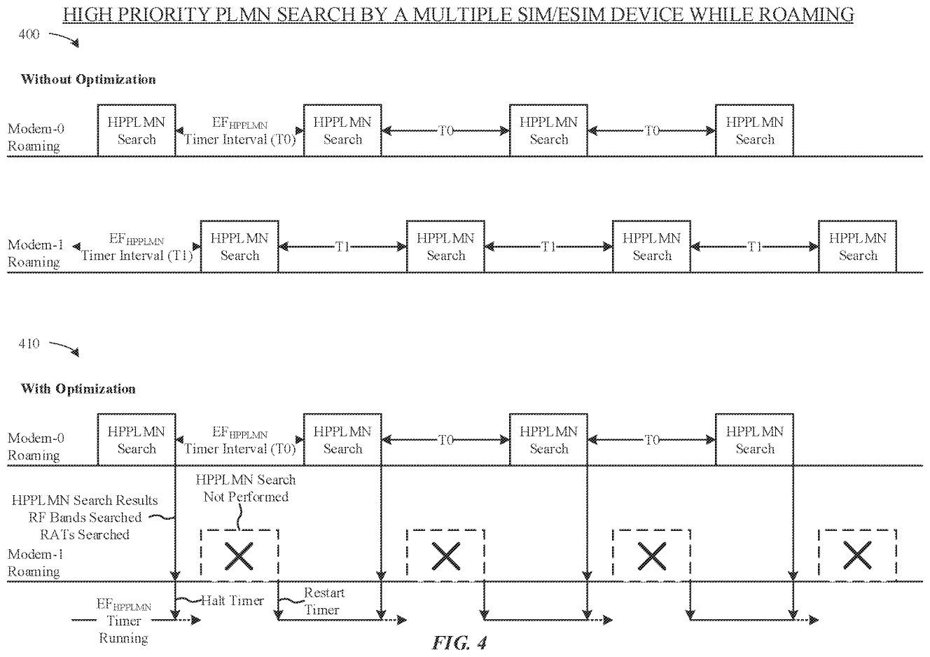

FIG. 4 illustrates diagrams 400, 410 of an exemplary optimization of high priority PLMN (HPPLMN) searching by a multi-SIM/eSIM wireless device. The multi-SIM/eSIM wireless device includes multiple SIMs/eSIMs of which two are active at the same time. Each SIM/eSIM is associated with an MNO 114, which need not be the same MNO 114. Each SIM/eSIM can include information regarding priorities for PLMN searching, e.g., a list of prior prioritized PLMNs, a set of RATs, a set of RF bands, etc. for the multi-SIM/eSIM wireless device when searching for a PLMN, such as when an OOS recovery procedure or when selecting a PLMN while roaming. In the example of FIG. 4, the multi-SIM/eSIM wireless device is also in a roaming state, e.g., in a geographic region in which a home PLMN (HPLMN) is not available for the multi-SIM/eSIM wireless device to camp on. One parameter specified by an MNO 114 and included in a SIM/eSIM is an elementary file (EF) specifying time intervals between HPPLMN searches, namely an EFHPPLMN parameter that indicates an amount of time (time interval) between HPPLMN searches. A modem of the multi-SIM/eSIM wireless device for a SIM/eSIM, while roaming and camped on a visiting PLMN that is not a highest priority PLMN for the SIM/eSIM, can set a timer value based on a value in the EFHPPLMN of the SIM/eSIM, initiate the timer, and start a next HPPLMN search after expiration of the timer. As shown in diagram 400, successive HPPLMN searches for a first modem-0 associated with a first SIM/eSIM can be separated by a time interval T0 specified by an EFHPPLMN value for the first SIM/eSIM; similarly, successive HPPLMN searches for a second modem-1 associated with a second SIM/eSIM can be separated by a time interval T1 specified by an EFHPPLMN value for the second SIM/eSIM. With shared wireless circuitry, the HPPLMN searches for different modems can be spaced to occur in non-overlapping times. Without HPPLMN search optimization, as indicated by diagram 400, each modem performs parallel HPPLMN searches, which can result in higher power consumption of limited battery power for the multi-SIM/eSIM wireless device than required, particularly when no highest priority PLMNs are detected, as each modem performs the same (or overlapping) searches of RATs and RF bands. Diagram 410 illustrates an example of optimizing the HPPLMN searching for the multi-SIM/eSIM device, where the first modem (modem-0) performs HPPLMN searches and provides results of the HPPLMN searches to the second modem (modem-1). The results can include indications of PLMNs detected, which radio access technologies (RATs) were searched, and which RF bands were searched. The second modem (modem-1) can stop an HPPLMN timer (if running) based on an indication of the HPPLMN search results from the first modem (modem-0), where the HPPLMN search results indicate that no HPPLMN for the second modem (modem-1) was found by the HPPLMN search by the first modem (modem-0) and all configured RATs and RF bands for the second modem (modem-1) were searched by the first modem (modem-0). The second modem (modem-1) can forgo performing its own parallel HPPLMN search as a result of the HPPLMN search results from the first modem (modem-0) and restart an HPPLMN timer at an appropriate time, e.g., to allow enough time for the first modem (modem-0) to perform a subsequent HPPLMN search result. Excluding HPPLMN searches by the second modem (modem-1) can conserve limited battery power that would otherwise be used to perform redundant (at least in part) PLMN searching. In some embodiments, the time interval T0 for the first modem (modem-0) and the time interval T1 for the second modem are identical. In some embodiments, the time intervals T0 and T1 are different for each modem. In some embodiments, detected PLMNs are reported by the first modem (modem-0) to the second modem (modem-1) during the HPPLMN search without waiting for completion of the HPPLMN search across all RATs and all RF bands. In some embodiments, the second modem (modem-1) can initiate an immediate search for a PLMN having a highest priority for the second modem (modem-1) after receiving an indication of detection of the highest priority PLMN from the first modem (modem-0). When a PLMN detected and reported by the first modem (modem-0) to the second modem (modem-1) that is not the highest priority PLMN for the second modem (modem-1), the second modem (modem-1) can wait for further PLMN search results from the first modem (modem-0), as a highest priority PLMN may still be detected by the first modem (modem-0).

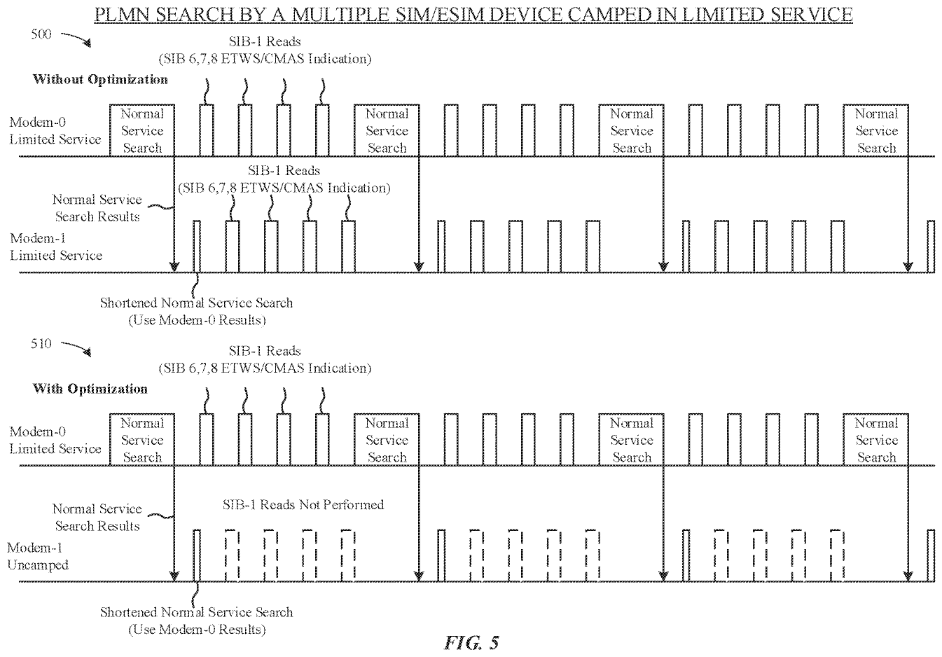

FIG. 5 illustrates diagrams 500, 510 of an exemplary optimization of PLMN searching by a multi-SIM/eSIM wireless device in a limited service mode. The multi-SIM/eSIM wireless device includes multiple SIMs/eSIMs of which two are active at the same time. Each SIM/eSIM is associated with an MNO 114, which need not be the same MNO 114. When unable to camp on a cellular wireless network in a normal service mode via active SIMs/eSIMs, the multi-SIM/eSIM wireless device can locate and camp on a cellular wireless network in a limited service mode, e.g., to provide access to emergency service calling and to receive system information regarding emergency alerts, e.g., monitor broadcast SI block type 1 (SIB-1) and SI block type 2 (SIB-2) messages that can provide information whether there are additional broadcast emergency alert messages, e.g., Earthquake and Tsunami Warning System (ETWS) and Commercial Mobile Alert System (CMAS) messages. As the broadcast emergency alert messages can be applicable to the multi-SIM/eSIM wireless device as a whole (and duplication of monitoring across multiple active SIMs/eSIMs in the multi-SIM/eSIM wireless device can be not required), one modem, e.g., a first modem (modem-0) can provide the limited service mode camping, SIB monitoring and PLMN searching for normal service, while the second modem (modem-1) can perform shortened PLMN searches without camping in a limited service mode in parallel with the first modem (modem-0) and relying on the first modem (modem-0) to monitor for emergency alert information. As shown in diagram 500, without PLMN search optimization, both the first modem (modem-0) and the second modem (modem-1) are camped in a limited service modem and monitoring broadcast SIB-1 messages to determines whether to read additional broadcast SIB-6, SIB-7, and/or SIB-8 messages to determine whether there's an indication of a forthcoming or existing ETWS/CMAS alert message. The first modem (modem-0) can perform at regular intervals a PLMN search to locate a PLMN on which the first modem (modem-0) can camp for normal service. Results of the PLMN search for normal service can be provided by the first modem (modem-0) to the second modem (modem-1), where the second modem (modem-1) can use the PLMN search results from the PLMN search by the first modem (modem-0) to shorten a time for performing a corresponding PLMN search for normal service by the second modem (modem-1). Without further optimization, however, both the first modem (modem-0) and the second modem (modem-1) can each independently, while camped in a limited service mode, wake from a power-reduced state to receive and process broadcast SIB-1 messages to detect any SIB-6, SIB-7, and/or SIB-8 messages for ETWS/CMAS communication. Parallel monitoring of the broadcast SIB-1 messages is not necessary, as the ETWS/CMAS communication would be applicable for the multi-SIM/eSIM wireless device independent of which SIMs/eSIMS are active. As shown in diagram 510, the second modem (modem-1) can remain in an uncamped state (when unable to camp in a normal service mode) and forgo receiving and processing the broadcast SIB-1 messages and rely instead on the first modem (modem-0) for meeting the limited service mode requirements. Both modem-0 and modem-1 can attempt to camp on a PLMN for normal service while in an uncamped or limited service mode. Should modem-0 lose limited service coverage, modem-1 can fallback to its own PLMN searches and use shared search results provided by modem-0. If an emergency services call is triggered while modem-0 (or modem-1) is in a limited service state, then the emergency services call will be routed via the modem through which the limited service state exists and normal procedures for searching for emergency services can be undertaken.

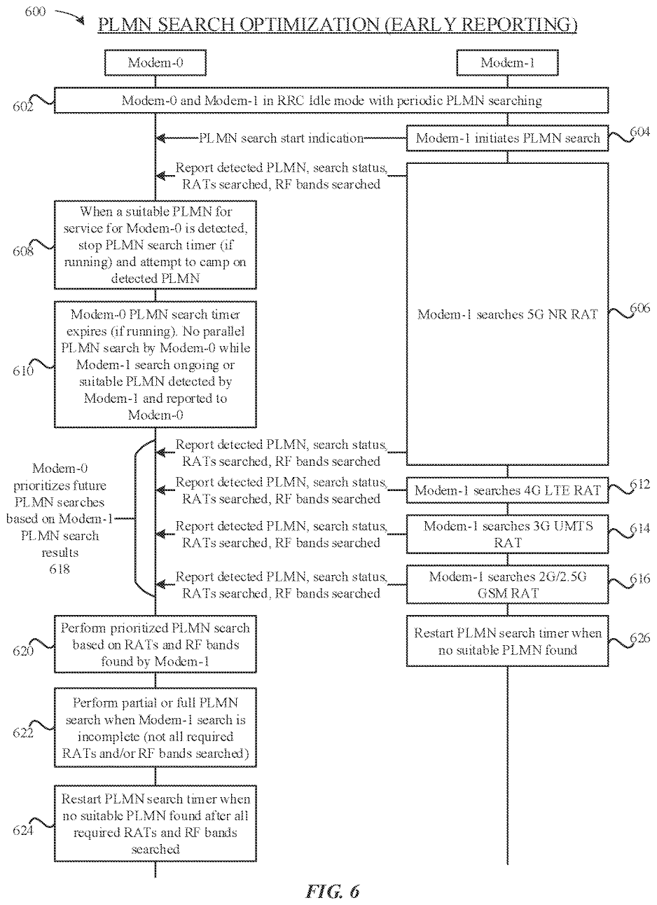

FIG. 6 illustrates a flow diagram 600 of an exemplary optimization of PLMN searching by a multi-SIM/eSIM wireless device with early PLMN search results reported between individual modems. At 602, a first modem (modem-0) and a second modem (modem-1) are each in a radio resource control (RRC) idle mode and performing periodic PLMN searching based on their own PLMN search timers. In some embodiments, modem-0 and modem-1 are roaming in a geographic region without access to a home PLMN. In some embodiments, modem-0 and modem-1 are performing an out-of-service (OOS) recovery procedure searching for a PLMN on which to camp. In the example illustrated in FIG. 6, a PLMN search timer for modem-O can expire during a PLMN search by modem-1. At 604, modem-1 initiates a PLMN search, which can occur as a result of a PLMN search timer expiration (e.g., associated with HPPLMN searches while roaming or with PLMN searches after a loss of service and performing a recovery of service procedure), and provides an indication to modem-O that a PLMN search has started. In some embodiments, modem-1 indicates a type of PLMN search initiated, e.g., a HPPLMN search while roaming or a general PLMN search for an OOS recovery procedure. Modem-1 performs the PLMN search across one or more radio access technologies (RATs) applicable to the capability of the multi-SIM/eSIM wireless device. In some embodiments, the RATs selected for the PLMN search are prioritized, e.g., more recent cellular wireless communication standardized RATs searched before earlier cellular RATs. In the example illustrated in FIG. 6, modem-1 searches a fifth generation (5G) new radio (NR) RAT first, followed by a fourth generation (4G) long term evolution (LTE) RAT, then a third generation (3G) universal mobile telecommunications system (UMTS) RAT, and lastly a second generation (2G/2.5G) global system for mobile communications (GSM) RAT. In some embodiments, modem-1 accounts for applicability of various RATs to the active SIM/eSIM associated with modem-1 and only searches those RATs that are applicable to the active SIM/eSIM. In some embodiments, modem-1 accounts for applicability of various RATs to one or more active SIMs/eSIMs, e.g., a SIM/eSIM associated with modem-1 and a SIM/eSIM associated with modem-0, and only searches those RATs that are applicable to the one or more active SIMs/eSIMs of the multi-SIM/eSIM wireless device. Modem-1 also performs the PLMN search across different RF bands applicable to the search RATs. In some embodiments, which RF bands are searched for a given RAT can also be prioritized and selected by modem-1, e.g., based on capabilities of the multi-SIM/eSIM wireless device, based on applicability to one or more active SIMs/eSIMs in the multi-SIM/eSIM wireless device, and/or based on a geographic region in which the multi-SIM/eSIM wireless device is operating. At 606, modem-1 performs searches for available PLMNs that provide cellular wireless service using a 5G NR RAT. In some embodiments, modem-1 reports to modem-0 when one or more PLMNs for a given RAT are detected. In some embodiments, modem-1 reports to modem-0 each PLMN detected for a given RAT. Modem-1 can report detected PLMNs from the PLMN search to modem-0 irrespective of an operating mode of modem-0, e.g., including when modem-0 is in an RRC connected mode. In addition to detected PLMNs, modem-1 can also report a status of the PLMN search, e.g., whether the PLMN search for the given RAT is complete or ongoing, an indication of RATs searched so far for the PLMN search as a whole, and an indication of RF bands searched for the particular RAT (or for all searched RATs). In some embodiments, modem-1 reports measured parameters and/or metrics for the detected PLMN, such as a carrier frequency, a signal strength, e.g., reference signal received power (RSRP) level, a signal quality, e.g., reference signal received quality (RSRQ) or signal-to-interference-plus-noise (SINR) level, or the like for modem-0 to assess suitability of the detected PLMN for use by modem-0. At 608, modem-0 processes information received from modem-1 for each detected and reported PLMN and determines based on the information (and, in some cases, based on additional measurements by modem-0), whether a detected PLMN is suitable for modem-0 to attempt camping on. If a suitable PLMN for service for modem-0 is detected, modem-0 can halt a PLMN search timer for modem-0, if running, and attempt to camp on the detected PLMN. It is important to note that each SIM/eSIM in a multi-SIM/eSIM is associated with its own MNO 114, which can vary for each SIM/eSIM, and have associated criteria provided by the MNO 114 for connectivity. As such, a PLMN detected by modem-1 may be suitable for modem-0, for modem-1, for both modem-0 and modem-1, or for neither modem-0 nor modem-1. Modem-1 can continue searching the 5G NR RAT while modem-0 determines suitability of previously reported PLMNs. When no suitable PLMN is reported by modem-1 to modem-0, modem-0 continues to wait for reported PLMN information from modem-1, including while its own PLMN search timer is running. At 610, the PLMN search timer for modem-0 expires (if running); however, modem-0 will not perform a parallel PLMN search while the PLMN search by modem-1 is still ongoing or when a suitable PLMN was previously detected by modem-1, reported to modem-0, and service via the suitable PLMN can be obtained by modem-0. Instead, modem-0 waits for additional PLMN search results from modem-1.

The PLMN search continues with modem-1 searching one or more additional RATs and reporting detected PLMN results to modem-0. At 612, modem-1 searches for available PLMNs that use a 4G LTE RAT. At 614, modem-1 searches for available PLMNs that use a 3G UMTS RAT. At 616, modem-1 searches for available PLMNs that use a 2G (or 2.5G) GSM RAT. Modem-1 can report detected PLMN results to modem-0 as soon as a PLMN is detected and information processed for the PLMN. At 618, modem-0 receives and processes PLMN results received from modem-1, including relevant parameters and metrics for different detected PLMNs, an updated PLMN search status at each report, an indication of a RATs searched, and an indication of RF bands searched. At 618, modem-0 can use the reported PLMN search results received from modem-1 to determine whether there is a suitable PLMN available for modem-0. Modem-0 can also use the PLMN search results to prioritize its own separate PLMN search (if undertaken after the PLMN search by modem-1 ends). In some embodiments, when a home PLMN for modem-0 or a highest priority PLMN for modem-0 is detected and reported to modem-0, modem-0 can attempt to locate and camp on the detected home PLMN or highest priority PLMN without waiting for additional PLMN search results from modem-1. Which PLMN (or PLMNs) are considered a highest priority PLMN for modem-0 can be the same or different from those for modem-1. Whether a PLMN is a highest priority PLMN for a modem also can depend on a geographic region in which the multi-SIM/eSIM wireless device is operating. After the PLMN search by modem-1 completes, when no suitable PLMN for modem-1 is detected by modem-1, at 626, modem-1 restarts its own PLMN search timer. At 620, after the PLMN search by modem-1 completes, modem-0 performs a prioritized PLMN search based on RATs and RF bands found and reported by modem-1. As such, modem-0 can perform a targeted PLMN search using knowledge of RATs and RF bands detected by modem-1 to speed its own PLMN search. If modem-0 detects a suitable PLMN, then modem-0 can attempt to camp on the detected PLMN. In some cases, the PLMN search by modem-1 can be incomplete, e.g., not all required RATs or RF bands for modem-0 were searched by modem-1, or modem-1 ends its PLMN search prematurely without searching all RATs or RF bands. It should be noted that required RATs and/or RF bands for each modem can be identical or can be different, and as such, modem-1 can perform a PLMN search applicable to its own active SIM/eSIM, which may have different requirements from an active SIM/eSIM associated with modem-0. In some embodiments, modem-0 uses PLMN search results including information regarding RATs and RF bands search by modem-1 to determine whether all required RATs and/or RF bands for modem-0 have been searched by modem-1. In some embodiments, modem-1 reports to modem-0 any unsearched RATs and/or RF bands when the PLMN search by modem-1 is incomplete. At 622, modem-0 can perform a partial or full PLMN search when the PLMN search for modem-1 is incomplete. Modem-0 can perform a partial PLMN search of RATs and/or RF bands that are required RATs and/or RF bands for modem-0 and not searched by modem-1 and not search RATs and/or RF bands already searched by modem-1. In some embodiments, when the PLMN search by modem-1 terminates prematurely, modem-0 performs a full PLMN search over supported RATs and/or RF bands applicable to modem-0 for the geographic region in which the multi-SIM/eSIM wireless device is operating. At 624, modem-0 can restart its own PLMN search timer when no suitable PLMN is found after all required RATs and RF bands for modem-0 are searched.

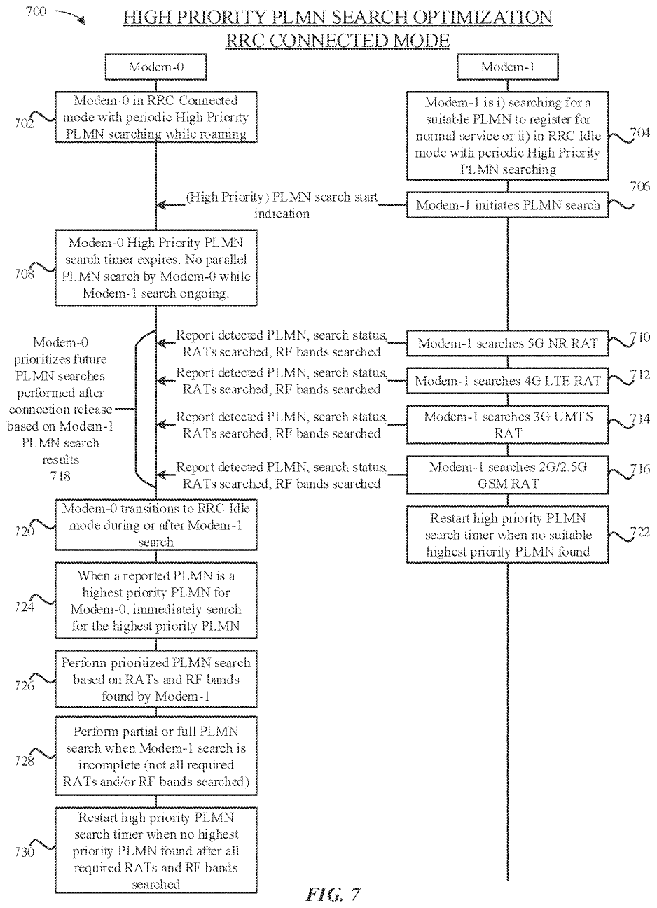

FIG. 7 illustrates a flow diagram 700 of an exemplary optimization of high priority PLMN (HPPLMN) searching with one modem of a multi-SIM/eSIM wireless device in a radio resource control (RRC) connected mode while roaming. At 702, modem-0 is in an RRC connected mode while roaming with a cellular wireless network using a first SIM/eSIM and, responsive to expiration of an HPPLMN timer for modem-0, moves to an RRC idle mode and performs periodic HPPLMN searching for modem-0. At 704, modem-1 is either i) searching for a suitable PLMN with which to register for normal service using a second SIM/eSIM or ii) in an RRC idle mode and performing periodic HPPLMN searching for modem-1 responsive to expiration of an HPPLMN timer for modem-1. While HPPLMN timers for each modem can run in parallel, results from an HPPLMN search by one modem can be used by the other modem, and therefore parallel, concurrent searches for PLMNs by multiple modems of the multi-SIM/eSIM wireless device are not required and can unnecessarily waste limited battery power. At 706, modem-1 initiates an HPPLMN search in response to expiration of its own HPPLMN timer (or initiated to recover a loss of service), where the HPPLMN search will be performed across all supported RF bands and all supported RATs for the geographic region in which the multi-SIM/eSIM wireless device is operating. The RATs and RF bands searched by modem-1 are prioritized, e.g., attempting to locate a suitable PLMN with a higher priority RAT and/or with an RF band applicable to a geographic region. The HPPLMN search by modem-1 can be performed across all supported RF bands and supported RATs for the current geographic region in which the multi-SIM/eSIM wireless device is operating. The HPPLMN search by modem-1 can occur including when modem-0 is in an RRC connected mode. In some embodiments, the HPPLMN search performed by modem-1 is tailored to requirements of modem-1, e.g., to the second SIM/eSIM being used for camping on the cellular wireless network by modem-1 when modem-1 is in the RRC connected mode. In some embodiments, the HPPLMN searched performed by modem-1 is based on requirements of the SIMs/eSIMs associated with modem-0 and modem-1. Additionally at 706, modem-1 provides an indication to modem-0 that a PLMN search has started. In some embodiments, modem-1 indicates a type of PLMN search initiated, e.g., a HPPLMN search while roaming or a general PLMN search for an OOS recovery procedure. At 708, an HPPLMN search timer for modem-0 expires. When the PLMN search by modem-1 is ongoing (e.g., based on receipt of a PLMN search initiation indication from modem-0 and lack of a corresponding PLMN search termination from modem-1), modem-0 can forgo performing a parallel PLMN search. At 710, modem-1 searches RF bands associated with a first RAT, e.g., a 5G NR RAT, for PLMNs and provides to modem-0 PLMN search results, including indications of detected PLMNs, a PLMN search status (e.g., ongoing, complete, terminated and complete, terminated and incomplete), an indication of RATs searched, and an indication of RF bands searched. Modem-1 continues the PLMN search, at 712, by searching for PLMNs in RF bands associated with a second RAT, e.g., a 4G LTE RAT, and provides additional PLMN search results to modem-0. At 714, modem-1 further continues the PLMN search across RF bands associated with a third RAT, e.g., a 3G UMTS RAT, and provides further PLMN results to modem-0. Finally, at 716, modem-1 performs a PLMN search across RF bands associated with a fourth RAT, e.g., a 2G/2.5G GSM RAT, and provides final PLMN results to modem-0. At 718, modem-0 prioritizes future PLMN searches performed after connection release based on the PLMN search results provided by modem-1. When a reported PLMN from modem-1 is an HPPLMN for modem-0, modem-0 can prioritize searching RF bands and RATs used by the reported HPPLMN during its own HPPLMN search performed after connection release. When none of the PLMNs reported by modem-1 are HPPLMNs for modem-0, and when all required RF bands and supported RATs for modem-0 and the geographic region in which the multi-SIM/eSIM wireless device is operating were searched by modem-1, then modem-0 can consider the PLMN search by modem-1 as complete for modem-0 and forgo performing a separate PLMN search. At 720, modem-0 transitions from the RRC connected mode to the RRC idle mode. Note that the RRC connection can be released while the PLMN search performed by modem-1 is ongoing or after the PLMN search performed by modem-1 completes. When the RRC connection is active at modem-0 at the completion of the PLMN search by modem-1, modem-0) can continue to wait until the active RRC connection is released and modem-0 returns to an RRC idle mode before performing a targeted, prioritized, partial, or full PLMN search of its own. At 724, when a PLMN reported by modem-1 to modem-0 is a highest priority PLMN for modem-0, modem-0 can immediately search for the highest priority PLMN. When no highest priority PLMN is reported by modem-1 or located by modem-0, at 726, modem-0 performs a prioritized search for PLMNs based on PLMN search results from modem-1, e.g., based on one or more RATs and/or one or more RF bands associated with PLMNs found by modem-1 and reported to modem-0. In some cases, the PLMN search by modem-1 can end without having searched all required RATs and/or RF bands applicable to modem-0, in which case, at 728, modem-0 performs a partial or full PLMN search of its own. At 730, when no highest priority PLMN is found, by modem-1 or by modem-0, and after all required RATs and RF bands for modem-0 have been searched, then modem-0 can restart its own PLMN search timer. Similarly, at 722, modem-1 restarts a corresponding high priority PLMN search timer when no highest priority PLMN applicable to modem-1 was found by modem-1 during its PLMN search.

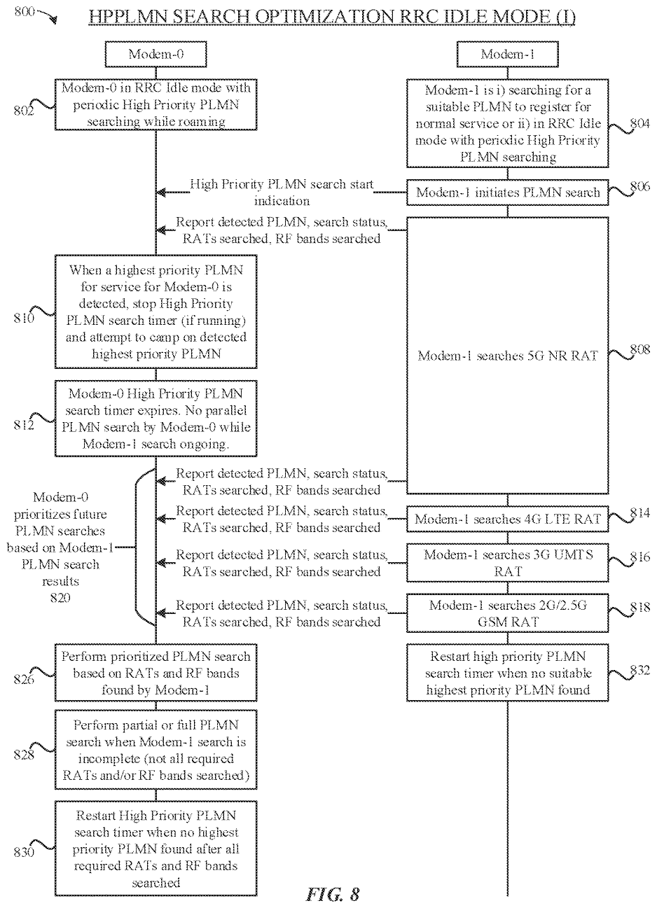

FIG. 8 illustrates a flow diagram 800 of an exemplary optimization of high priority PLMN (HPPLMN) searching with both modems of a multi-SIM/eSIM wireless device in a radio resource control (RRC) idle mode while roaming. At 802, modem-0 is in an RRC idle mode and performing periodic HPPLMN searches while the multi-SIM/eSIM wireless device is roaming. At 804, modem-1 is either i) searching for a suitable PLMN with which to register for normal service using a second SIM/eSIM or ii) in an RRC idle mode and performing periodic HPPLMN searching for modem-1 responsive to expiration of an HPPLMN timer for modem-1. Periodic searches by each of modem-0 and modem-1 can be performed based on expiration of separate HPPLMN timers maintained by modem-0 and modem-1 respectively. To reduce power consumption due to parallel searches of identical or overlapping PLMN search spaces, the multi-SIM/eSIM wireless device can provide results from an HPPLMN search by one modem to the other to assist the second modem to locate a PLMN (if recovering from an OOS condition) or a higher priority PLMN (if already camped on a PLMN). The HPPLMN search of one modem can also result in the second modem learning of a highest priority PLMN for the second modem earlier than would occur when waiting to perform its own HPPLMN search. At 806, modem-1 initiates an HPPLMN search responsive to expiration of an HPPLMN search timer (or a PLMN search initiated to recover from an out-of-service condition), where the HPPLMN search is across all supported RF bands and RATs for the geographic region where the multi-SIM/eSIM wireless device is operating. Modem-1 provides an indication to modem-0 that the HPPLMN search by modem-1 is started. Modem-1 provides PLMN search results, including detected PLMNs, an indication of a status of the HPPLMN search (e.g., ongoing, complete, terminated and complete, or terminated an incomplete), an indication of RATs searched, and an indication of RF bands searched, where the PLMN search results are provided by modem-1 to modem-0 throughout the HPPLMN search rather than collected and provided at the end of the HPPLMN search. Incremental PLMN search results from modem-1 can more quickly provide information on which modem-0 can take action. At 808, modem-1 performs an HPPLMN search across RF bands of a 5G NR RAT and provides PLMN search results to modem-0 when a 5G NR RAT PLMN is detected. When a highest priority PLMN for modem-0 is detected and reported by modem-1, modem-0 can halt its own HPPLMN timer (if running) and attempt to camp on the detected highest priority PLMN. Detection and reporting of a highest priority PLMN for modem-0 by modem-1 can occur any time during the complete HPPLMN search by modem-1. At 812, a running HPPLMN search timer for modem-0 expires; however, modem-0 will not perform a parallel PLMN search while the HPPLMN search by modem-1 is ongoing and instead wait for results from the HPPLMN search of modem-1, which can inform future PLMN searches performed by modem-0. At 814, modem-1 performs an HPPLMN search across RF bands of a 4G LTE RAT and provides PLMN search results to modem-0 when a 4G LTE RAT PLMN is detected. At 816, modem-1 performs an HPPLMN search across RF bands of a 3G UMTS RAT and provides PLMN search results to modem-0 when a 3G UMTS RAT PLMN is detected. At 818, modem-1 performs an HPPLMN search across RF bands of a 2G/2.5G GSM RAT and provides PLMN search results to modem-0 when a 2G/2.5G GSM RAT PLMN is detected. At 820, modem-0 prioritizes future HPPLMN (or general PLMN) searches using the PLMN search results provided by modem-1. When a PLMN reported by modem-1 to modem-0 is a higher priority PLMN for modem-0 than a PLMN already in use by modem-0, then modem-0, at 826, can perform a prioritized PLMN search over those RF bands and RATs for which the respective higher priority PLMN was detected, after the PLMN search by modem-1 completes. If any PLMN detected and reported by modem-1 to modem-0 is a highest priority PLMN for modem-0, then modem-0 can immediately attempt to camp on the highest priority PLMN without waiting for additional PLMN search results from modem-1. When not all required RATs and/or RF bands for modem-0 were searched by modem-1, then modem-0, at 828, can perform a partial or full PLMN search, where modem-0 can use PLMN search results provided by modem-1 to prioritize, focus, and/or prune the PLMN search. In particular, modem-0 should avoid searching again RATs and/or RF bands which were completely searched by modem-1. When none of the detected PLMNs reported by modem-1 to modem-0 are a higher priority PLMN than a PLMN already used by modem-0, and all required RATs and RF bands for modem-0 applicable to the geographic region in which the multi-SIM/eSIM wireless device is roaming were searched by modem-1 (or by modem-0 in a partial or full PLMN search at 828), then modem-0, at 830, can restart its own HPPLMN timer without performing an additional HPPLMN search. As discussed previously, each SIM/eSIM of the multi-SIM/eSIM can have its own associated RATs and associated RF bands to search, and therefore modem-0 and modem-1 can each be configured to use different RAT and/or RF band search spaces. In some embodiments, modem-0 searches only those RF bands and/or RATs that were not searched and PLMN search results provided by modem-1.

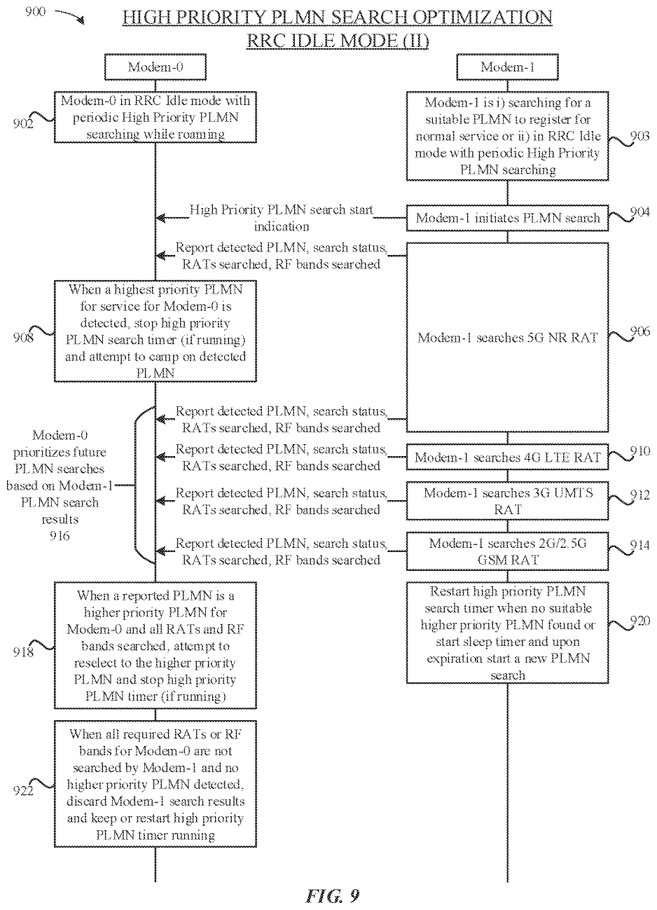

FIG. 9 illustrates a flow diagram 900 of another exemplary optimization of high priority PLMN searching by a multi-SIM/eSIM wireless device with multiple modems in an RRC idle state. At 902, modem-0 is in an RRC idle state and configured for periodic high priority PLMN searches, e.g., based on expiration of an HPPLMN search timer with a value determined by an EFHPPLMN parameter specified by the SIM/eSIM associated with modem-0. At 903, modem-1 is either i) searching for a suitable PLMN with which to register for normal service using a second SIM/eSIM or ii) in an RRC idle mode and performing periodic HPPLMN searching for modem-1 responsive to expiration of an HPPLMN timer for modem-1. At 904, modem-1 initiates a PLMN search, which can be in response to expiration of an HPPLMN timer for modem-1 or can be initiated to recover from a loss of service (e.g., an OOS condition), where the PLMN search can be performed across all supported RATs and corresponding RF bands for a geographic region in which the multi-SIM/eSIM wireless device is operating. In some cases, the multi-SIM/eSIM wireless device is roaming and each modem is camped on a PLMN based on their respective SIM/eSIM. Modem-1 can perform the HPPLMN search to determine if there is a higher priority PLMN available for camping on. Modem-1 provides an indication to modem-0 when starting the PLMN search, which can include an indication that the PLMN search is a HPPLMN search or a more general PLMN search (e.g., for OOS recovery). At 906, modem-1 performs a PLMN search across RF bands associated with a 5G NR RAT and provides to modem-0 PLMN results, which can include detected PLMNs, a status of the PLMN search, such as ongoing, complete, terminated and fully searched, terminated and only partially searched, an indication of RATs searched, and an indication of associated RF bands searched. In some embodiments, modem-1 detects a PLMN that is suitable for modem-1, e.g., when performing a recovery from OOS procedure, and attempts to camp on the PLMN before reporting the detected PLMN to modem-0. In some embodiments, modem-1 detects a higher priority PLMN for modem-1 than a PLMN on which modem-1 is already camped and attempts to reselect to the higher priority PLMN before reporting the detected higher priority PLMN to modem-0. A higher priority PLMN for modem-1 may not necessarily be a higher priority PLMN for modem-0. For example, modem-0 and modem-1 are associated with different SIM/eSIMs that each can have different prioritized PLMN lists. At 908, modem-0 determines whether a PLMN reported by modem-1 is a highest priority PLMN for service for modem-0, and when the PLMN reported is a highest priority PLMN, modem-0 halts a high priority PLMN timer (if running) and attempts to camp on the detected highest priority PLMN. When a PLMN reported by modem-1 to modem-0 is not the highest priority PLMN, modem-0 can use the PLMN results to prioritize a future PLMN search performed by modem-0. Modem-1 continues the PLMN search at 910 searching across RF bands associated with a 4G LTE RAT and provides updated PLMN search results to modem-0, including an indication of detected PLMNs, a search status, RATs cumulatively searched, and associated RF bands searched. Modem-1 further continues the PLMN search at 912 searching across RF bands associated with a 3G UMTS RAT and provides additional PLMN search results to modem-0. Finally, modem-1 performs a PLMN search across RF bands associated with the a 2G/2.5G RAT at 914 and provides PLMN search results to modem-0. With each PLMN result provided by modem-1, modem-0 can determine whether a highest priority PLMN for modem-0 is detected and immediately attempt to camp on the highest priority PLMN after stopping a high priority PLMN search timer (if running). At 918, when a PLMN reported by modem-1 is a higher priority PLMN for modem-0 (than a PLMN on which modem-0 is currently camped), modem-0 can attempt to reselect to the higher priority PLMN and halt the HPPLMN timer (if running). At 922, when modem-1 has not searched all RATs and RF bands required for modem-0, and no higher priority PLMN is detected by modem-1 and reported to modem-0, then modem-0 can discard the PLMN search results provided by modem-1 and maintain running of the HPPLMN timer. Later, upon expiration of the HPPLMN timer, modem-0 can perform its own PLMN search across either all RATs and RF bands required for modem-0 or across those RATs and RF bands not searched previously by modem-1. After completion of the PLMN search, modem-1, at 920 can restart the HPPLMN search timer when no suitable higher priority PLMN was found by the PLMN search or start a sleep timer and upon expiration of the sleep timer start a new PLMN search.

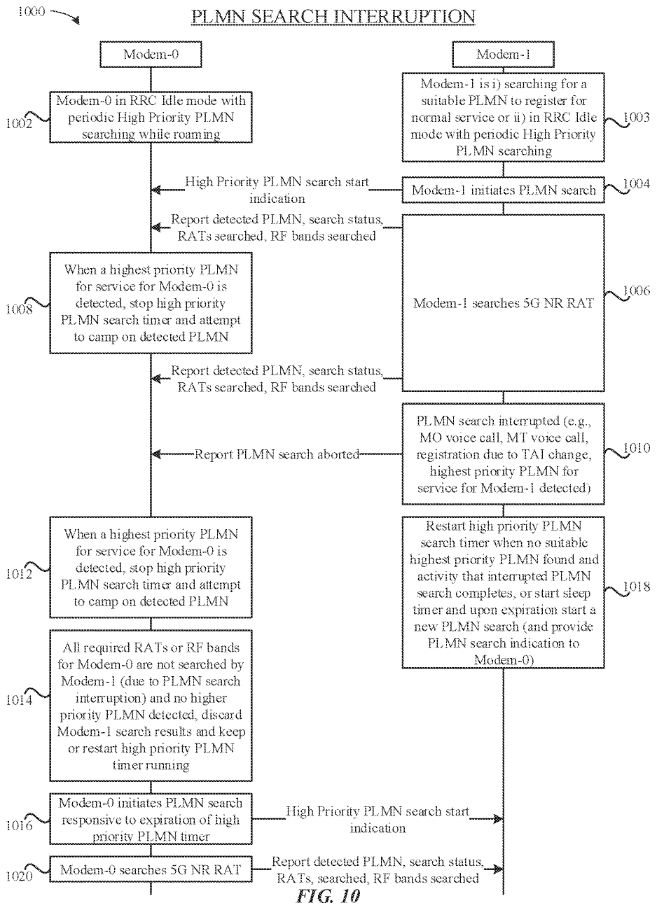

FIG. 10 illustrates a flow diagram 1000 of an exemplary optimization of PLMN searching with an interruption of the PLMN searching by a multi-SIM/eSIM wireless device. When the multi-SIM/eSIM wireless device is executing a PLMN search, which can be a high priority PLMN search to locate a highest or higher priority PLMN while roaming, or a PLMN search for a wireless network on which to camp for limited access service, or a PLMN search to locate a suitable PLMN when recovering from an out-of-service condition, the multi-SIM/eSIM wireless device can encounter scenarios in which the ongoing PLMN search can be aborted. At the start of the PLMN search, modem-1 provides an indication to modem-0 of the PLMN search, and during the PLMN search, modem-1 provides PLMN search results. When the PLMN search is interrupted, modem-1 can also provide an indication of the interruption of the PLMN search immediately to modem-0. In some cases, modem-0 can initiate a separate PLMN search responsive to the indication that the PLMN search of modem-1 was interrupted and terminated early before all RATs and associated RF bands were searched. At 1002, modem-0 is in an RRC idle state and configured for periodic high priority PLMN searches, e.g., based on expiration of an HPPLMN search timer with a value determined by an EFHPPLMN parameter specified by the SIM/eSIM associated with modem-0. At 1003, modem-1 is either i) searching for a suitable PLMN with which to register for normal service using a second SIM/eSIM or ii) in an RRC idle mode and performing periodic HPPLMN searching for modem-1 responsive to expiration of an HPPLMN timer for modem-1. At 1004, modem-1 initiates a PLMN search, which can be responsive to expiration of an HPPLMN timer for modem-1 or can be initiated to recover from a loss of server (e.g., an OOS condition), where the PLMN search can be performed across all supported RATs and corresponding RF bands for a geographic region in which the multi-SIM/eSIM wireless device is operating. In some cases, the multi-SIM/eSIM wireless device is roaming and each modem is camped on a PLMN based on their respective SIM/eSIM. Modem-1 can perform the HPPLMN search to determine if there is a higher priority PLMN available for camping on. Modem-1 provides an indication to modem-0 when starting the PLMN search, which can include an indication that the PLMN search is a HPPLMN search or a more general PLMN search (e.g., for OOS recovery). At 1006 modem-1 begins the PLMN search by searching RF bands of a 5G NR RAT and provides PLMN search results to modem-0 during the PLMN search. The PLMN search results can include an indication of detected PLMNs, a search status, which RATs have been searched, and which RF bands of the RATs have been searched. Modem-0 processes the PLMN search results received from modem-1, and when a highest priority PLMN for service for modem-0 is detected, modem-0, at 1008, stops an HPPLMN search timer for modem-0 and attempts to camp on the detected PLMN. For PLMNs detected other a highest priority PLMN, modem-0 uses the information to inform its own future PLMN searches. In the scenario illustrated in FIG. 10, the PLMN search undertaken by modem-1 is interrupted at 1010 due to one or more triggering criteria, such as origination of an outgoing voice call by modem-1, reception of an incoming voice call by modem-1, a registration for modem-1 due to a tracking area identifier (TAI) change, or a highest priority PLMN for modem-1 is detected causing the PLMN search by modem-1 to be suspended. Modem-1 provides an indication to modem-0 that the PLMN search has been aborted, where the indication can be included in a most recent set of PLMN search results (e.g., as a search status value). At 1012, modem-0 determines whether a highest priority PLMN for service for modem-0 was reported by modem-1 in the PLMN search results. When a highest priority PLMN for modem-0 is detected, modem-0 can stop an HPPLMN search timer and attempt to camp on the detected highest priority PLMN. At 1014, when all required RATs or RF bands for modem-0 were not searched by modem-1, e.g., due to interruption of the PLMN search by modem-1, and no higher priority PLMN than already used by modem-0 was detected, then modem-0 can allow an existing HPPLMN search timer to continue running (or restart the HPPLMN search timer for modem-0). At 1016, modem-0 initiates its own PLMN search responsive to expiration of the HPPLMN search timer for modem-0 and provides an indication of the initiation of the HPPLMN search to modem-1. Modem-1, at 1018, restarts its own HPPLMN search timer at the completion of the activity that interrupted the PLMN search, e.g., the voice call terminates, the registration completes, etc. When no suitable highest priority PLMN for modem-1 was detected by the previous PLMN search (and not acted upon by modem-1 before the interruption of the PLMN search), modem-1 can restart its own HPPLMN search timer or start a sleep timer and upon expiration start a new PLMN search (when a PLMN search by modem-0 is not ongoing). At 1020, modem-0 begins the PLMN search by searching for PLMNs in RF bands of a 5G NR RAT and provides PLMN search results to modem-1. Additional search by modem-0 through additional RATs can occur as described herein for modem-1 conducting a PLMN search.

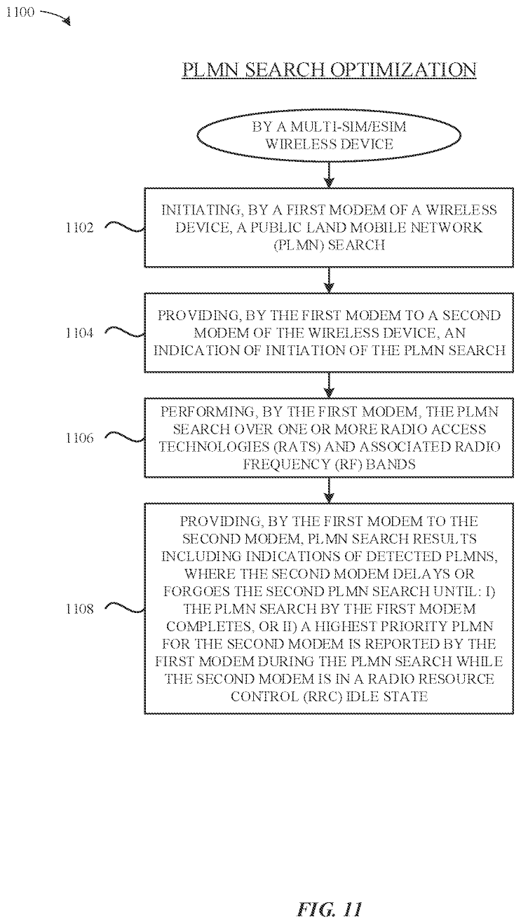

FIG. 11 illustrates a flowchart 1100 of an exemplary method for optimization of PLMN searching by a multi-SIM/eSIM wireless device. At 1102, a first modem of the multi-SIM/eSIM wireless device initiates a PLMN search. At 1104, the first modem provides to the second modem of the multi-SIM/eSIM wireless device an indication that the PLMN search has initiated. At 1106, the first modem performs the PLMN search over one or more RATs and associated RF bands. At 1108, the first modem provides to the second modem PLMN search results including indications of detected PLMNs, where the second modem can delay or forgo a second PLMN search until the PLMN search by the first modem completes or until a highest priority PLMN for the second modem is reported by the first modem during the PLMN search while the second modem is in an RRC idle state.

In some embodiments, the first modem includes a first SIM or eSIM 208 enabled on the multi-SIM/eSIM wireless device and associated with a first MNO 114, and the second modem includes a second SIM or eSIM 208 enabled on the multi-SIM/eSIM wireless device and associated with a second MNO different from the first MNO. In some embodiments, the first modem performs the PLMN search over RATs and associated RF bands applicable to the first SIM or eSIM and the first MNO. In some embodiments, the second PLMN search by the second modem includes one or more unsearched RATS or associated RF bands applicable to the second SIM or eSIM and the second MNO. In some embodiments, the first modem and the second modem are each executing a recovery of service procedure from an out-of-service (OSS) state while the multi-SIM/eSIM wireless device is in a roaming geographic region. In some embodiments, the first modem provides to the second modem indications of each PLMN as detected during the PLMN search as part of the PLMN search results. In some embodiments, the second modem is in an RRC idle state in an out-of-service recovery mode, and the second modem is configured to: i) determine whether a PLMN detected by the first modem is suitable for the second modem, and ii) when the PLMN detected by the first modem is suitable for the second modem, stop a PLMN search timer for the second modem when running, and attempt to camp on the PLMN without waiting for completion of the PLMN search by the first modem. Suitability of a PLMN for a modem can depend on a requirements of a SIM/eSIM associated with the modem. In some embodiments, the second modem delays or forgoes the second PLMN search responsive to expiration of a PLMN search timer for the second modem during the PLMN search by the first modem. In some embodiments, the second modem is configured to: i) determine, after completion of the PLMN search by the first modem, that no PLMN detected by the first modem is suitable for the second modem, and ii) perform a second PLMN search prioritizing RATs and associated RF bands detected by the first modem in the second PLMN search. In some embodiments, the first modem provides to the second modem an indication of RATs and/or associated RF bands not searched by the first modem in the PLMN search, and the second PLMN search, performed by the second modem includes one or more of the RATs and/or associated RF bands not searched by the first modem in the PLMN search. In some embodiments, the one or more of the RATs and/or associated RF bands are applicable to a second eSIM of the second modem and for a geographic region in which the multi-SIM/eSIM wireless device is operating. In some embodiments, the PLMN search results provided by the first modem to the second modem includes indications for one or more of: detected PLMNs, whether the PLMN search is partial or complete, cumulative RATs searched, or cumulative RF bands searched. In some embodiments, the PLMN search by the first modem is a high priority PLMN search; the second PLMN search by the second modem is a second high priority PLMN search; the second modem is in an RRC connected state during at least a portion of the high priority PLMN search by the first modem; and the second modem delays performing the second high priority PLMN search until after connection release and transitioning to the RRC idle state. In some embodiments, the PLMN search results from the first modem includes the highest priority PLMN for the second modem, and the second modem prioritizes a search for the highest priority PLMN at initiation of the second high priority PLMN search. In some embodiments, the PLMN search results from the first modem does not include the highest priority PLMN for the second modem, and the second modem waits to perform the second high priority PLMN search until the high priority PLMN search by the first modem completes. In some embodiments, the PLMN search by the first modem is a high priority PLMN search; a high priority PLMN search timer for the second modem expires during the PLMN search by the first modem; and the second modem is configured to perform the second PLMN search after completion of the PLMN search by the first modem and restart the high priority PLMN search timer when no suitable highest priority PLMN for the second modem is detected during the second PLMN search. In some embodiments, the PLMN search by the first modem is a high priority PLMN search; the PLMN search includes all RATs and RF bands applicable to the second modem; the PLMN search results includes a PLMN having a higher priority for the second modem; and the second modem is configured to stop a high priority PLMN timer for the second modem, and attempt to camp on the PLMN having the higher priority. In some embodiments, when the PLMN search by the first modem terminates without all RATs or RF bands applicable to the second modem being searched and no higher priority PLMN was detected by the PLMN search, the second modem is configured to discard the PLMN search results from the first modem and initiate a separate PLMN search responsive to expiration of a high priority PLMN timer for the second modem.

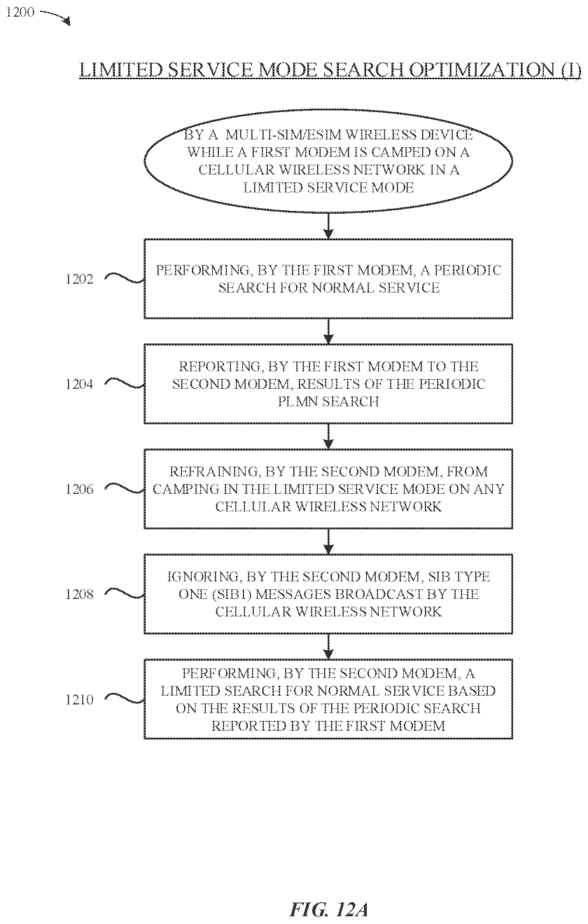

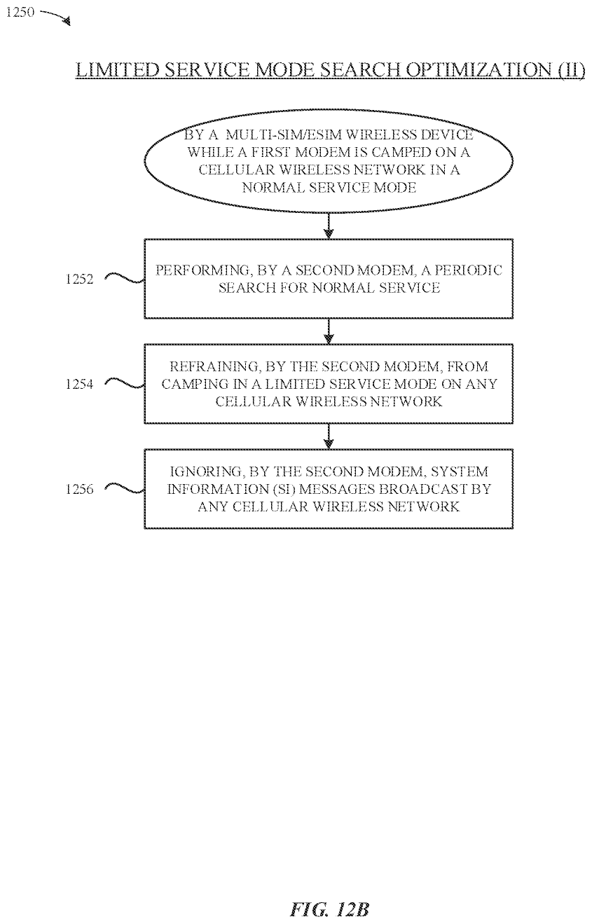

FIG. 12A illustrates a flowchart 1200 of an exemplary method for optimization of PLMN searching by a multi-SIM/eSIM wireless device in a limited service mode. At 1202, a first modem of the multi-SIM/eSIM wireless device performs a periodic search for normal service. At 1204, the first modem reports to the second modem results of the periodic PLMN search. At 1206, the second modem refrains from camping in the limited service mode on any cellular wireless network while the first modem is camped on a cellular wireless network in the limited service mode. At 1208, the second modem ignores system information (SI) messages, such as SI block type one (SIB1) messages, broadcast by the cellular wireless network on which the first modem is camped. The second modem relies on the first modem to receive any emergency alert messages, such as Earthquake Tsunami Warning System (ETWS) or Commercial Mobile Alert System (CMAS) emergency alert messages. At 1210, the second modem performs a limited search for normal service based on the results of the periodic search reported by the first modem.

FIG. 12B illustrates a flowchart 1250 of another exemplary method for optimization of PLMN searching by a multi-SIM/eSIM wireless device while a first modem of the multi-SIM/eSIM wireless device is camped on a cellular wireless network in a normal service mode. At 1252, a second modem of the multi-SIM/eSIM wireless device performs a periodic search for a suitable PLMN on which to camp for a normal service. At 1254, the second modem refrains from camping in a limited service mode on the cellular wireless network in a limited service mode on the cellular wireless network or on any other cellular wireless network. At 1256, the second modem of the multi-SIM/eSIM wireless device ignores system information messages broadcast by cellular wireless networks, including the cellular wireless network on which the first modem is camped. The second modem relies on the first modem to receive any emergency alert messages, such as Earthquake Tsunami Warning System (ETWS) or Commercial Mobile Alert System (CMAS) emergency alert messages.

### Representative Exemplary Apparatus

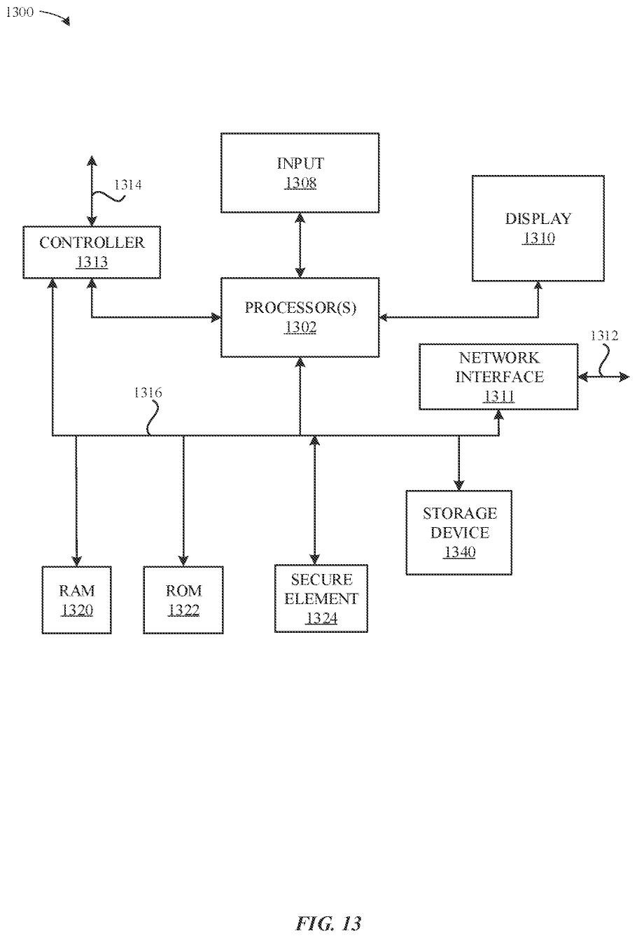

FIG. 13 illustrates in block diagram format an exemplary computing device 1300 that can be used to implement the various components and techniques described herein, according to some embodiments. In particular, the detailed view of the exemplary computing device 1300 illustrates various components that can be included in a multi-SIM/eSIM wireless device. As shown in FIG. 13, the computing device 1300 can include one or more processors 1302 that represent microprocessors or controllers for controlling the overall operation of computing device 1300. In some embodiments, the computing device 1300 can also include a user input device 1308 that allows a user of the computing device 1300 to interact with the computing device 1300. For example, in some embodiments, the user input device 1308 can take a variety of forms, such as a button, keypad, dial, touch screen, audio input interface, visual/image capture input interface, input in the form of sensor data, etc. In some embodiments, the computing device 1300 can include a display 1310 (screen display) that can be controlled by the processor(s) 1302 to display information to the user (for example, information relating to incoming, outgoing, or active communication sessions). A data bus 1316 can facilitate data transfer between at least a storage device 1340, the processor(s) 1302, and a controller 1313. The controller 1313 can be used to interface with and control different equipment through an equipment control bus 1314. The computing device 1300 can also include a network/bus interface 1311 that couples to a data link 1312. In the case of a wireless connection, the network/bus interface 1311 can include wireless circuitry, such as a wireless transceiver and/or baseband processor. The computing device 1300 can also include a secure element 1324. The secure element 1324 can include an eUICC 108.

The computing device 1300 also includes a storage device 1340, which can include a single storage or a plurality of storages (e.g., hard drives), and includes a storage management module that manages one or more partitions within the storage device 1340. In some embodiments, storage device 1340 can include flash memory, semiconductor (solid state) memory or the like. The computing device 1300 can also include a Random-Access Memory (RAM) 1320 and a Read-Only Memory (ROM) 1322. The ROM 1322 can store programs, utilities or processes to be executed in a non-volatile manner. The RAM 1320 can provide volatile data storage, and stores instructions related to the operation of the computing device 1300.

### Wireless Terminology

In accordance with various embodiments described herein, the terms “wireless communication device,” “wireless device,” “mobile device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) LTE, LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode user equipment (UE) can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A method for public land mobile network (PLMN) searching on a wireless device, the method comprising:
by the wireless device:
initiating, by a first modem of the wireless device, a PLMN search;
providing, by the first modem to a second modem of the wireless device, an indication of initiation of the PLMN search;
performing, by the first modem, the PLMN search over one or more radio access technologies (RATs) and associated radio frequency (RF) bands;
providing, by the first modem to the second modem, PLMN search results including indications of detected PLMNs; and
prioritizing, by the second modem, a second PLMN search based on the PLMN search results,
wherein the second modem delays or forgoes the second PLMN search until:
the PLMN search by the first modem completes, or
a highest priority PLMN for the second modem is reported by the first modem during the PLMN search while the second modem is in a radio resource control (RRC) idle state.

2. The method of claim 1, wherein:
the first modem includes a first SIM or eSIM enabled on the wireless device and associated with a first mobile network operator (MNO); and
the second modem includes a second SIM or eSIM enabled on the wireless device and associated with a second MNO different from the first MNO.

3. The method of claim 2, wherein:
the first modem performs the PLMN search over RATs and associated RF bands applicable to the first SIM or eSIM and the first MNO.

4. The method of claim 3, wherein:
the second PLMN search includes one or more unsearched RATs or associated RF bands applicable to the second SIM or eSIM and the second MNO.

5. The method of claim 1, wherein the first modem and the second modem are each executing a recovery of service procedure from an out-of-service (OOS) state while the wireless device is in a roaming geographic region.

6. The method of claim 1, wherein the providing PLMN search results includes providing indications of each PLMN as detected during the PLMN search.

7. The method of claim 6, wherein:
the second modem is in a radio resource control (RRC) idle state in an out-of-service recovery mode; and
the method further comprises, by the second modem:
determining whether a PLMN detected by the first modem is suitable for the second modem; and
when the PLMN detected by the first modem is suitable for the second modem:
stopping a PLMN search timer for the second modem when running; and
attempting to camp on the PLMN without waiting for completion of the PLMN search by the first modem.

8. The method of claim 1, wherein the second modem delays or forgoes the second PLMN search responsive to expiration of a PLMN search timer for the second modem during the PLMN search by the first modem.

9. The method of claim 1, further comprising:
determining, by the second modem after completion of the PLMN search by the first modem, no PLMN detected by the first modem is suitable for the second modem; and
performing, by the second modem, the second PLMN search prioritizing RATs and associated RF bands detected by the first modem.

10. The method of claim 1, further comprising:
providing, by the first modem to the second modem, an indication of RATs and/or associated RF bands not searched by the first modem in the PLMN search; and
the second PLMN search includes one or more of the RATs and/or associated RF bands not searched by the first modem in the PLMN search.

11. The method of claim 10, wherein the one or more of the RATs and/or associated RF bands are applicable to a second eSIM of the second modem and for a geographic region in which the wireless device is operating.

12. The method of claim 1, wherein the PLMN search results includes indications for one or more of: detected PLMNs, whether the PLMN search is partial or complete, cumulative RATs searched, or cumulative RF bands searched.

13. The method of claim 1, wherein:
the PLMN search by the first modem is a high priority PLMN search;
the second PLMN search by the second modem is a second high priority PLMN search;
the second modem is in an RRC connected state during at least a portion of the high priority PLMN search by the first modem; and
the second modem delays performing the second high priority PLMN search until after connection release and transitioning to the RRC idle state.

14. The method of claim 13, wherein:
the PLMN search results from the first modem includes the highest priority PLMN for the second modem; and
the second modem prioritizes a search for the highest priority PLMN at initiation of the second high priority PLMN search.

15. The method of claim 13, wherein:
the PLMN search results from the first modem does not include the highest priority PLMN for the second modem; and
the second modem waits to perform the second high priority PLMN search until the high priority PLMN search by the first modem completes.

16. The method of claim 1, wherein:
the PLMN search by the first modem is a high priority PLMN search;
a high priority PLMN search timer for the second modem expires during the PLMN search by the first modem; and
the method further comprises the second modem:
performing the second PLMN search after completion of the PLMN search by the first modem; and
restarting the high priority PLMN search timer when no suitable highest priority PLMN for the second modem is detected during the second PLMN search.

17. The method of claim 1, wherein:
the PLMN search by the first modem is a high priority PLMN search;
the PLMN search includes all RATs and RF bands applicable to the second modem;
the PLMN search results includes a PLMN having a higher priority for the second modem; and
the method further comprises the second modem:
stopping a high priority PLMN timer for the second modem; and
attempting to camp on the PLMN having the higher priority.

18. The method of claim 1, wherein when the PLMN search by the first modem terminates without all RATs or RF bands applicable to the second modem being searched and no higher priority PLMN was detected by the PLMN search, the method further comprises the second modem:
discarding the PLMN search results from the first modem; and
initiating a separate PLMN search responsive to expiration of a high priority PLMN timer for the second modem.

19. A method for reduced monitoring of system information broadcast (SIB) messages by a wireless device while a first modem of the wireless device is camped on a cellular wireless network in a limited service mode:
performing, by the first modem, a periodic PLMN search for normal service;
reporting, by the first modem to a second modem of the wireless device, results of the periodic PLMN search;
refraining, by the second modem, from camping in the limited service mode on the cellular wireless network or on another cellular wireless network;
ignoring, by the second modem, SIB type one (SIB-1) messages broadcast by the cellular wireless network; and
performing, by the second modem, a limited search for normal service based on the results of the periodic PLMN search reported by the first modem.

20. A method for reduced monitoring of system information broadcast (SIB) messages by a wireless device while a first modem of the wireless device is camped on a cellular wireless network in a normal service mode:
performing, by a second modem, a periodic PLMN search for a suitable PLMN for normal service;
refraining, by the second modem, from camping in a limited service mode on the cellular wireless network or on another cellular wireless network while the first modem is camped on the cellular wireless network in the normal service mode; and
ignoring, by the second modem, system information (SI) messages broadcast by any cellular wireless network.

21.-23. (canceled)
